(19) United States
(12) Patent Application Publication
(10) Pub. No.: US 2026/0019570 A1
(43) Pub. Date: Jan. 15, 2026

(54) DERIVATION OF INTRA PREDICTION MODE MODES USING CONTENT ANALYSIS

(71) Applicant: Nokia Technologies Oy, Espoo (FI)

(72) Inventors: Krit PANUSOPONE, San Diego, CA (US); Seungwook HONG, San Diego, CA (US); Limin WANG, San Diego, CA (US); Döne BUGDAYCI SANSLI, Tampere (FI); Jani LAINEMA, Tampere (FI)

(21) Appl. No.: 18/930,698

(22) Filed: Oct. 29, 2024

Related U.S. Application Data
(60) Provisional application No. 63/668,871, filed on Jul. 9, 2024.

(51) Int. Cl. H04N 19/11; H04N 19/14; H04N 19/176

(52) U.S. Cl. CPC H04N 19/11; H04N 19/14; H04N 19/176

(57) ABSTRACT

An apparatus includes at least one processor; and at least one memory storing instructions that, when executed by the at least one processor, cause the apparatus at least to: analyze an analysis area associated with a prediction block of a coding unit; and derive at least one intra prediction mode, based on the analyzing of the analysis area associated with the prediction block of the coding unit that does not have a directionality from its coding mode.

### TECHNICAL FIELD

The examples and non-limiting embodiments relate generally to derivation of intra prediction mode modes using content analysis.

### BACKGROUND

It is known to perform data compression and data decompression in a multimedia system.

### SUMMARY

In accordance with an embodiment, an apparatus includes at least one processor; and at least one memory storing instructions that, when executed by the at least one processor, cause the apparatus at least to: analyze an analysis area associated with a prediction block of a coding unit that does not have a directionality from its coding mode; and derive at least one intra prediction mode, based on the analyzing of the analysis area associated with the prediction block of the coding unit. In an embodiment, the directionality comprises an obvious directionality. In one or more examples, the obvious directionality may comprise a direction of prediction pattern used to generate the prediction block.

In accordance with another embodiment, a method includes analyzing an analysis area associated with a prediction block of a coding unit that does not have a directionality from its coding mode; and deriving at least one intra prediction mode, based on the analyzing of the analysis area associated with the prediction block of the coding unit. In an embodiment, the directionality comprises an obvious directionality. In one or more examples, the obvious directionality may comprise a direction of prediction pattern used to generate the prediction block.

In accordance with yet another embodiment, an apparatus includes means for analyzing an analysis area associated with a prediction block of a coding unit that does not have a directionality from its coding mode; and means for deriving at least one intra prediction mode, based on the analyzing of the analysis area associated with the prediction block of the coding unit. In an embodiment, the directionality comprises an obvious directionality. In one or more examples, the obvious directionality may comprise a direction of prediction pattern used to generate the prediction block.

In accordance with still another embodiment, a computer readable medium includes instructions stored thereon for performing at least the following: analyzing an analysis area associated with a prediction block of a coding unit that does not have a directionality from its coding mode; and deriving at least one intra prediction mode, based on the analyzing of the analysis area associated with the prediction block of the coding unit. In an embodiment, the directionality comprises an obvious directionality. In one or more examples, the obvious directionality may comprise a direction of prediction pattern used to generate the prediction block.

### BRIEF DESCRIPTION OF THE DRAWINGS

The foregoing embodiments and other features are explained in the following description, taken in connection with the accompanying drawings, wherein:

FIG. 1 shows an analysis area for decoder side intra mode derivation (DIMD) consisting of samples outside of a prediction block.

FIG. 2 shows an analysis area for DIMD consisting of samples inside a prediction block.

FIG. 3 shows an analysis area for template based intra mode derivation (TIMD) consisting of samples outside of a prediction block.

FIG. 4 shows mode derivation using samples in the prediction block as an analysis area, in accordance with an example.

FIG. 5. shows mode derivation using samples in the prediction block as an analysis area, in accordance with another example.

FIG. 6 shows different DIMD operations for the intra prediction mode (IPM) mode derivation, in accordance with an example.

FIG. 7 shows an analysis area for DIMD to derive an low frequency non-separable transform (LFNST) mode for a spatial geometric partition mode (SGPM)/geometric partition mode (GPM) coding unit (CU).

FIG. 8 shows an analysis area for DIMD to derive an LFNST mode for each 4×4 subblock in a SGPM/GPM CU.

FIG. 9 shows an encoder according to an embodiment.

FIG. 10 shows a decoder according to an embodiment.

FIG. 11 is a block diagram illustrating a system in accordance with an example.

FIG. 12 is an example apparatus configured to implement the examples described herein.

FIG. 13 shows a representation of an example of non-volatile memory media used to store instructions that implement the examples described herein.

FIG. 14 is an example method, based on the examples described herein.

### DETAILED DESCRIPTION OF EXAMPLE EMBODIMENTS

Versatile Video Coding (VVC) is a new international video coding standard and Enhanced Compression Model (ECM) built on top of VVC is potentially a future video coding standard that is currently under the development sponsored by JVET. Both VVC and ECM are block-based video coding standards, where an input picture is divided into coding tree units (CTUs), and each CTU may be further split into CUs. A CU (or block) is coded in either inter coding mode or intra coding mode. If the block is in inter coding mode, encoder searches for a temporal prediction block in reference picture(s), and signals decoder how to find the same prediction block in reference picture(s) at the decoder end. If the block is in intra coding mode, the encoder constructs a spatial prediction block from the current picture, and signals to the decoder how to form the same spatial prediction block from the current picture at the decoder end. If the block is in inter coding mode, encoder constructs an associated temporal prediction block in the reference picture, and signal decoder how to form the same temporal prediction block from the reference picture at the decoder end.

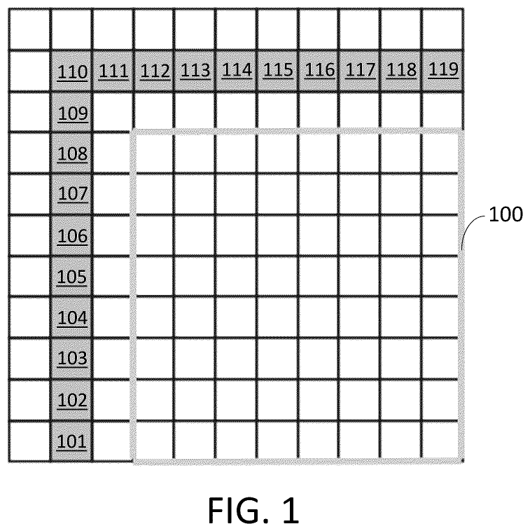

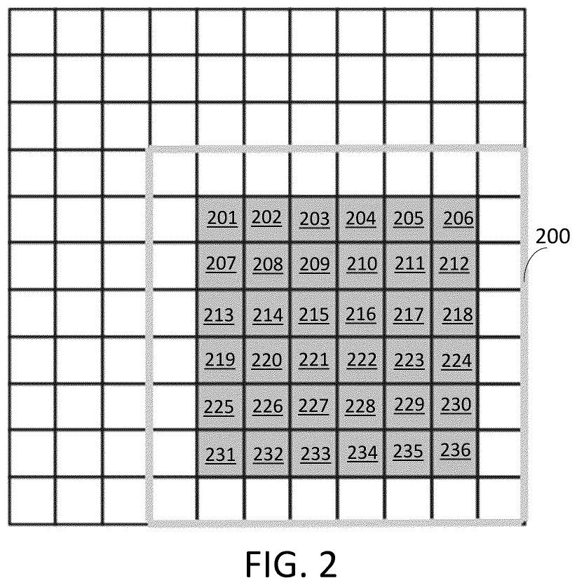

DIMD is an analysis tool used by ECM to derive content pattern in a block by analyzing samples in template associated with the block. Specifically, directional gradient consisting of direction and strength is computed for certain pixels in the template as shown in FIG. 1 and FIG. 2. Aggregated gradient for each direction from samples in the template is then used to build a histogram of gradients. The histogram determines one or mode(s) based on histogram bin values to be used in intra prediction.

FIG. 1 shows an analysis area for DIMD consisting of samples outside of a prediction block 100, namely samples 101, 102, 103, 104, 105, 106, 107, 108, 109, 110, 111, 112, 113, 114, 115, 116, 117, 118, and 119. FIG. 2 shows an analysis area for DIMD consisting of samples inside a prediction block 200, namely samples 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, and 236.

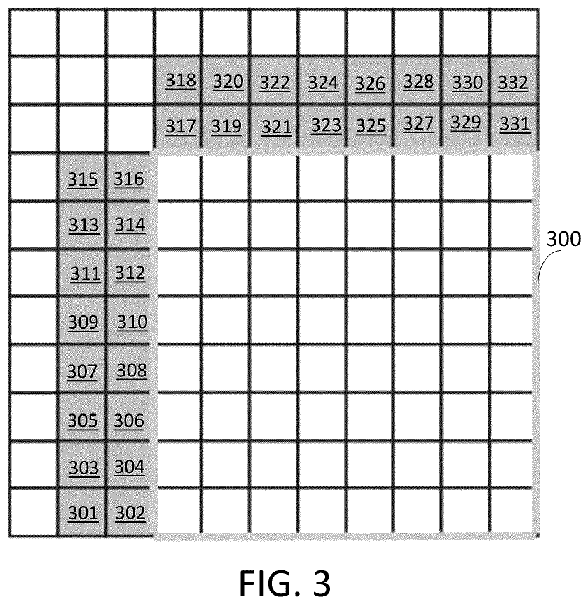

TIMD is another analysis tool used by ECM to derive content pattern in a block by searching for direction that provides the lowest matching cost between prediction (based on the test direction) and reconstruction samples of the template. An example of TIMD template is shown in FIG. 3. FIG. 3 shows an analysis area for TIMD consisting of samples outside of a prediction block 300, namely samples 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, and 332.

Intra Prediction Mode (IPM) is a coding information associated with every 4×4 subblock. However, IPM is not necessarily the same as the coding mode used by the subblock. IPM is used to build intra MPM list for subsequent block.

Low Frequency Non-Separable Transform (LFNST) is a transform tool used by VVC and ECM to further transform residual output of primary transform. LFNST mode is derived using realized intra prediction mode of the CU. Notice that, the realized intra prediction mode is not necessarily the same as IPM.

In ECM, IPM and LFNST modes are derived based on coding mode of the CU. For CU coded using coding mode with an obvious directionality, that is the direction of prediction pattern used to generate the prediction block, such as angular modes, its coding mode is used to derive IPM and LFNST modes. For regular inter and affine CU, LFNST mode is derived based on output of DIMD analysis of the associated prediction block of the CU and IPM mode is derived by inheriting IPM mode of its reference block indicated by motion information of the CU. For a spatial geometric partition mode (SGPM) CU or a geometric partition mode (GPM) CU, LFNST mode is derived based on the split line associated with the GPM mode and IPM mode is derived for each 4×4 subblock based on coding mode of the partition that each 4×4 subblock belongs to. If the partition uses inter coding mode, the same process for IPM derivation is used for 4×4 subblocks in that partition. If the partition uses intra coding mode, IPM is determined based on intra prediction mode used for that partition. For Intra Template Matching (ITMP), Matrix weighted Intra Prediction (MIP), and Extrapolation filter-based Intra Prediction (EIP), LFNST mode is derived based on output of DIMD analysis of the associated prediction block of the CU and IPM mode is set to planar mode.

It is critical to derive IPM and LFNST modes accurately since they are used to determine prediction mode for subsequent CU and transform mode for the current CU. By inheriting IPM of the reference block, the IPM may correspond to a block from a POC in a distant past and is no longer an accurate representation of the content in the current block.

Additionally, the way ECM derives LFNST mode is not optimal as it uses the split line used by a SGPM/GPM CU in its LFNST derivation. The split line, however, represents a boundary between two objects in a CU and is not an accurate representation of the content in the current block.

Unlike ECM, the examples described herein relate to using an analysis tool such as DIMD or TIMD in the IPM/LFNST mode derivation process of inter CU including regular inter, affine, subblock transform (SBT) and intra CU such as SGPM.

In an embodiment, one or more IPM/LFNST mode(s) are derived based on one or more dominant direction(s) of pattern in the block. The dominant directions can be determined by analyzing subset of samples in the prediction block or a template of reconstructed samples around the prediction block.

For regular inter/affine/IBC/ITMP/MIP/EIP CU, this invention first generates the final prediction block and then applies analysis tool such as DIMD/TIMD to the analysis area in/around the prediction block. The outcome of the analysis is then used to determine IPM/LFNST mode for all 4×4 subblocks in the CU according to a pre-determined table/function.

Analysis area is an area associated with a prediction block that is available at decoder. It can include samples in the prediction block (e.g., FIG. 2) and/or reconstructed samples in a template around the prediction block (e.g., FIG. 1). Samples in the reference area are analyzed by statistical method such as gradient analysis used by DIMD or by searching method such as template matching used by TIMD (e.g., FIG. 3).

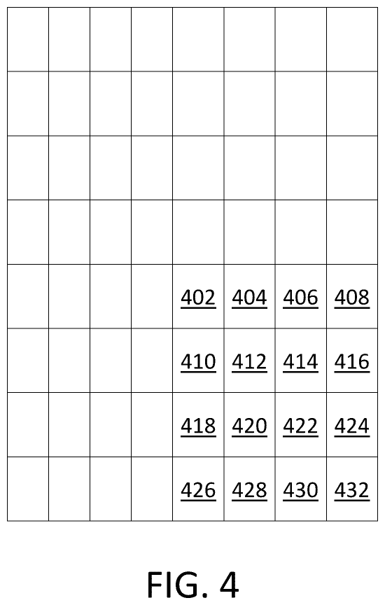

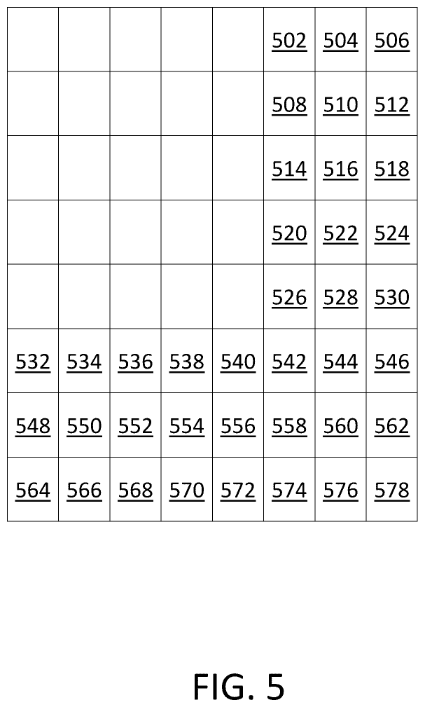

For IPM/LFNST, or other, mode derivation using samples in the prediction block as an analysis area, gradient strength for locations in a pre-defined area (such as bottom right corner of the block illustrated in FIG. 4. or bottom and right borders illustrated in FIG. 5) in DIMD process are given higher weights than those of the remaining sample locations in the block. For example, weights for a determined subset of locations in a block can be one while the rest of the locations can have a weight of zero. Especially for the IPM use, where derived directionality of one block is used as input for intra prediction processes of other blocks on the right and below the block, it can be advantageous to use a weighting having larger weights for locations on the right and bottom borders of the block. This kind of selection practically minimized the distance of the gradient measurements and the blocks where those gradient measurements are used as part of the sample prediction process, leading into coding efficiency improvements. Naturally any number of sample locations can be included in the process, not limited to the selection of locations illustrated in FIG. 4 and FIG. 5.

FIG. 4 shows, for IPM/LFNST, mode derivation using samples in the prediction block as an analysis area, in accordance with an example. As shown in FIG. 4, gradient strength of samples in area 402, 404, 406, 408, 410, 412, 414, 416, 418, 420, 422, 424, 426, 428, 430, and 432 are weighted higher than those outside the area 402, 404, 406, 408, 410, 412, 414, 416, 418, 420, 422, 424, 426, 428, 430, and 432.

FIG. 5. shows, for IPM/LFNST, mode derivation using samples in the prediction block as an analysis area, in accordance with another embodiment. As shown in FIG. 5, gradient strength of samples in area 502, 504, 506, 508, 510, 512, 514, 516, 518, 520, 522, 524, 526, 528, 530, 532, 534, 536, 538, 540, 542, 544, 546, 548, 550, 552, 554, 556, 558, 560, 562, 564, 566, 568, 570, 572, 574, 576, and 578 are weighted higher than those outside the area 502, 504, 506, 508, 510, 512, 514, 516, 518, 520, 522, 524, 526, 528, 530, 532, 534, 536, 538, 540, 542, 544, 546, 548, 550, 552, 554, 556, 558, 560, 562, 564, 566, 568, 570, and 572.

In another embodiment, the IPM of a regular inter/affine/IBC/ITMP/MIP/EIP CU is derived for each of the smaller blocks within the CU. An analysis area is an area associated with the smaller block and samples in the reference area are analyzed by a statistical method to determine the IPM mode of all 4×4 subblocks within the smaller block. The size of the smaller block can be 4×4, 4×8, 8×8, or any other dimensions.

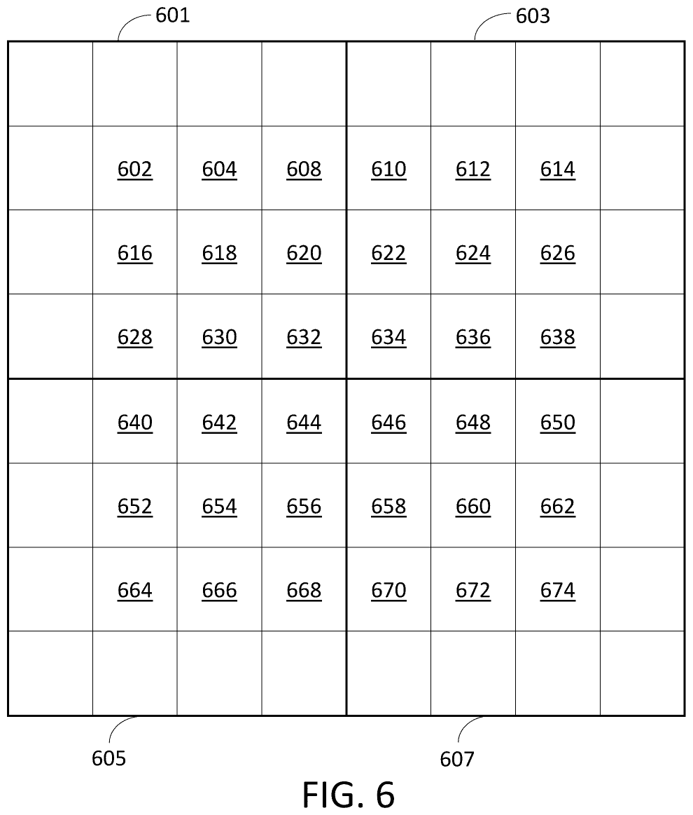

The IPM mode derivation when analysis area is associated with a smaller block can be processed differently based on location of the smaller block relative to the prediction block or the reconstruction block associated with the CU. In an embodiment, the smaller block not on the CU boundary used gradients of all samples in the smaller block, while the smaller block on the CU boundary used gradients of all samples not that are situated along CU boundary (e.g., FIG. 6). Gradient strengths for each sample in the reference area can be weighted differently as described in above (e.g., FIGS. 4 and 5).

FIG. 6 shows different DIMD operations for the IPM mode derivation when analysis area is associated with a smaller block based on location of smaller blocks (e.g., size 4×4) relative to the prediction block or the reconstruction block. FIG. 6 includes 4 smaller blocks, for example, 4×4 smaller blocks 601, 603, 605, and 607. Analysis area of the smaller block 601 includes samples 602, 604, 608, 616, 618, 620, 628, 630, and 632. Analysis area of the smaller block 603 includes samples 610, 612, 614, 622, 624, 626, 634, 636, and 638. Analysis of the smaller block 605 includes samples 640, 642, 644, 652, 654, 656, 664, 666, and 668. Analysis of the smaller block 607 includes samples 646, 648, 650, 658, 660, 662, 670, 672, and 674.

Gradient strengths for the samples 602, 604, 606, 608, 610, 612, 614, 616, 618, 620, 622, 624, 626, 628, 630, 632, 634, 636, 638, 640, 642, 644, 646, 648, 650, 652, 654, 656, 658, 660, 662, 664, 666, 668, 670, 672, and 674 can be weighted differently as described in above (e.g., FIGS. 4 and 5).

For SGPM/GPM CU, this invention derives LFNST mode by first generates the blended prediction block from the two partitions in the CU, then applies analysis tool such as DIMD/TIMD to the analysis area in/around the blended prediction block. The outcome of the analysis is then used to determine LFNST mode according to a pre-determined table/function. In an embodiment, the analysis area for DIMD and TIMD is shown in FIGS. 2 and 3, respectively.

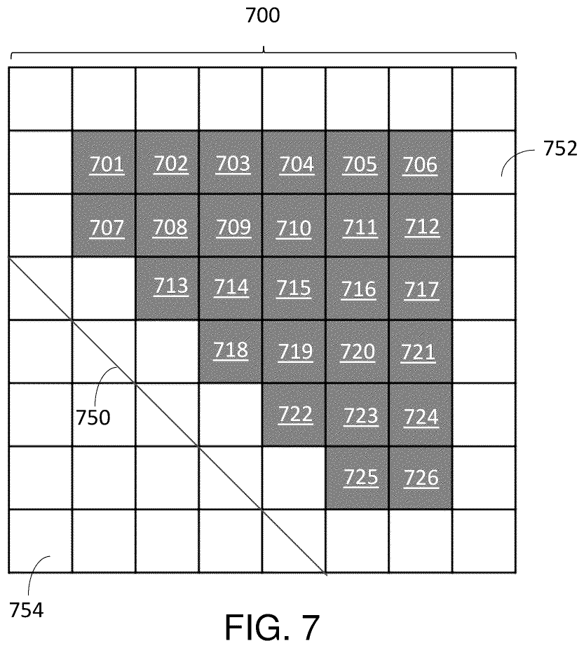

In another embodiment, the analysis area for DIMD is defined according to the area of a selected partition (e.g., FIG. 7). This embodiment is useful when one partition is much larger than the other partition in the SGPM, GPM CU.

FIG. 7 shows an analysis area for DIMD to derive an LFNST mode for a SGPM/GPM CU 700. The analysis area includes a number of samples of the SGPM/GPM CU 700, namely samples 701, 702, 703, 704, 705, 706, 707, 708, 709, 710, 711, 712, 713, 714, 715, 716, 717, 718, 719, 720, 721, 722, 723, 724, 725, and 726 of a first partition 752 of the SGPM/GPM CU 700. As shown in FIG. 7, the line 750 divides the CU 700 into a first partition 752 and a second partition 754, where the first partition 752 is larger than the second partition 454 due to the first partition 752 comprising more samples than the second partition 754.

For IPM mode derivation for SGPM/GPM CU, IPM is determined for every 4×4 subblock within the CU. This invention utilizes analysis tool such as DIMD or TIMD to determine IPM mode. In an embodiment, the analysis area for DIMD and TIMD is shown in FIG. 2 and FIG. 3, respectively. In this embodiment, all 4×4 subblocks use the same IPM mode derived for the CU.

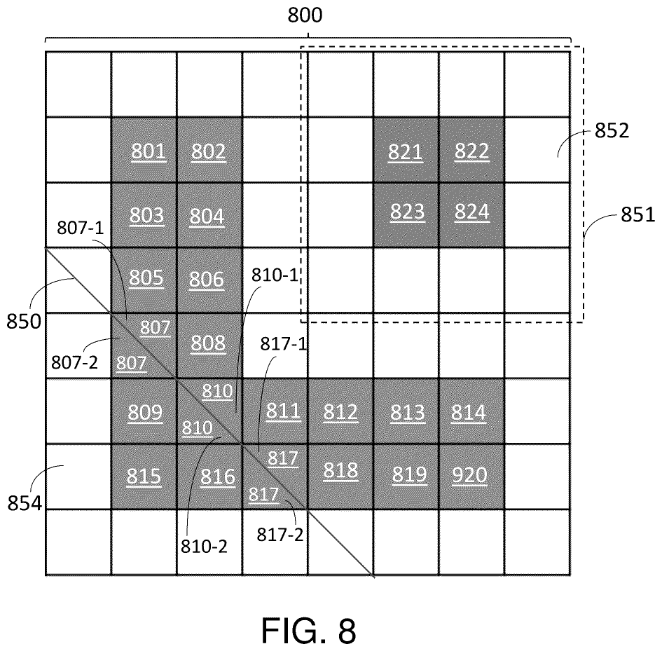

Referring to FIG. 8, in another embodiment, IPM is determined per 4×4 subblock (e.g. 4×4 subblock 851) of a CU 800 by first checking whether the subblock belongs to the first partition 852, the second partition 854, or the blended area of the two partitions, then DIMD is applied to the reference area in the first partition 852, the second partition 854, and the blended area and their results are used to derive the IPM mode for all 4×4 subblocks in their respective partitions. An example of this embodiment is shown in FIG. 8.

FIG. 8 shows an analysis area for DIMD to derive an LFNST mode for each 4×4 subblock in a SGPM/GPM CU 800. The line 850 divides the CU 800 into a first partition 852 and a second partition 854. The first partition 852 of CU 800 includes samples 801, 802, 803, 804, 805, 806, a portion 807-1 of sample 807, 808, a portion 810-1 of sample 810, 811, 812, 813, 814, a portion 817-1 of sample 817, 818, 819, 820, 821, 822, 823, and 824. The first partition 852 may include more samples than described herein. The second partition 854 of CU 800 includes a portion 807-2 of sample 807, sample 809, a portion 810-2 of sample 810, 815, 816, and a portion 817-2 of sample 817. The second partition 854 may include more samples than described herein.

A reference area (or analysis area) in the first partition comprises samples 821, 822, 823, and 824. A blended area (or a reference area or analysis area that is in both the first partition 852 and the second partition 854) includes samples 801, 802, 803, 804, 805, 806, 807, 808, 809, 810, 811, 812, 813, 814, 815, 816, 817, 818, 819, and 820.

In another embodiment, both IPM and LFNST derivations are performed using the same process and reference area, and the analysis output is used to derive both IPM and LFNST modes. For CU coded using coding mode without an obvious directionality, IPM derivation using the proposed analysis method only applies when LFNST mode derivation is needed (LFNST index is non-zero). In one or more examples, the obvious directionality may comprise a direction of prediction pattern used to generate the prediction block.

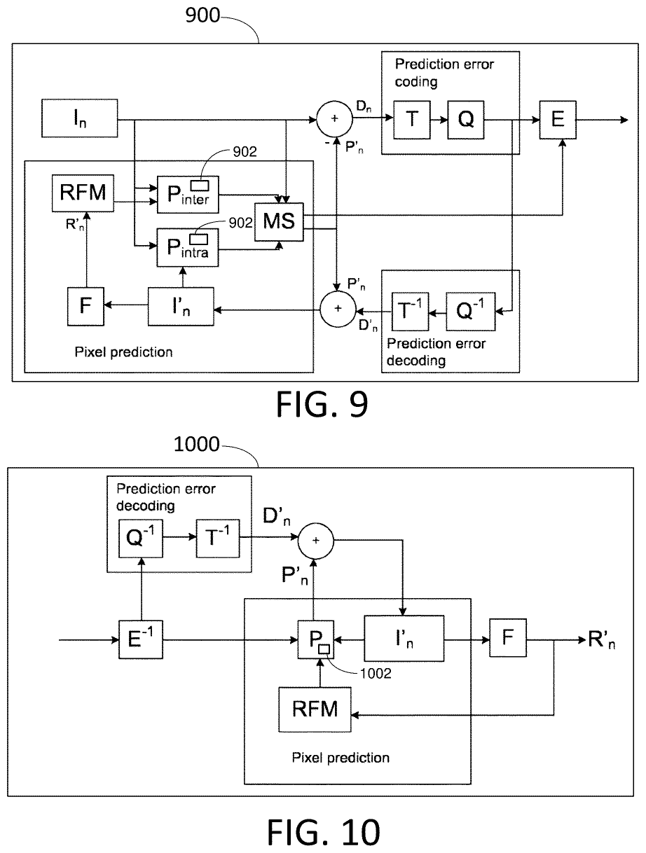

FIG. 9 shows an encoder 900 according to an embodiment. FIG. 9 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (E), a reference frame memory (RFM), inter prediction (P^{inter}), intra prediction (P^{intra}), mode selection (MS) and filtering (F). Derivation 902 within inter prediction (P^{inter}) and intra prediction (P^{intra}) implements the examples described herein related to derivation of IPM and LFNST modes using content analysis.

FIG. 10 shows a decoder 1000 according to an embodiment. FIG. 10 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). Derivation 1002 within prediction (either inter or intra) (P) implements the examples described herein related to derivation of IPM and LFNST modes using content analysis.

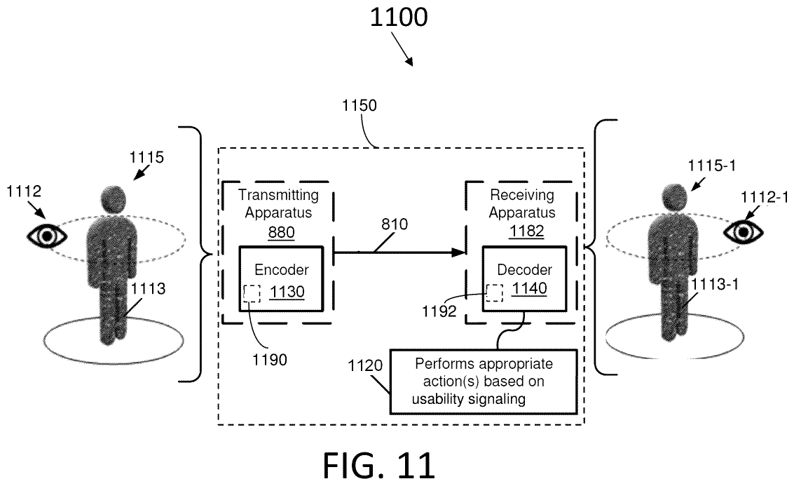

FIG. 11 is a block diagram illustrating a system 1100 in accordance with several examples. In an example, the encoder 1130 is used to encode an image or video from the scene 1115, and the encoder 1130 is implemented in a transmitting apparatus 1180. The encoder 1130 produces a bitstream 1110 comprising signaling that is received by the receiving apparatus 1182, which implements a decoder 1140. The encoder 1130 sends the bitstream 1110 that comprises the herein described signaling. The decoder 1140 forms the image or video for the scene 1115-1, and the receiving apparatus 1182 would present this to the user, e.g., via a smartphone, television, or projector among many other options.

In some examples, the transmitting apparatus 1180 and the receiving apparatus 1182 are at least partially within a common apparatus, and for example are located within a common housing 1150. In other examples the transmitting apparatus 1180 and the receiving apparatus 1182 are at least partially not within a common apparatus and have at least partially different housings. Therefore in some examples, the encoder 1130 and the decoder 1140 are at least partially within a common apparatus, and for example are located within a common housing 1150. For example the common apparatus comprising the encoder 1130 and decoder 1140 implements a codec. In other examples the encoder 1130 and the decoder 1140 are at least partially not within a common apparatus and have at least partially different housings, but when together still implement a codec.

In some examples, 3D media from the capture (e.g., volumetric capture) at a viewpoint 1112 of the scene 1115, which includes a person 1113) is converted via projection to a series of 2D representations with occupancy, geometry, attributes and/or displacements. Additional atlas information is also included in the bitstream to enable inverse reconstruction. For decoding, the received bitstream 1110 is separated into its components with atlas information; occupancy, geometry, displacement, and attribute 2D representations. A 3D reconstruction is performed to reconstruct the scene 1115-1 created looking at the viewpoint 1112-1 with a “reconstructed” person 1113-1. The “−1” are used to indicate that these are reconstructions of the original. As indicated at 1120, the decoder 1140 performs an action or actions based on the received signaling.

Encoding 1190 performs the encoding-side examples described herein related to derivation of IPM and LFNST modes using content analysis. Decoding 1192 performs the decoding-side examples described herein related to derivation of IPM and LFNST modes using content analysis.

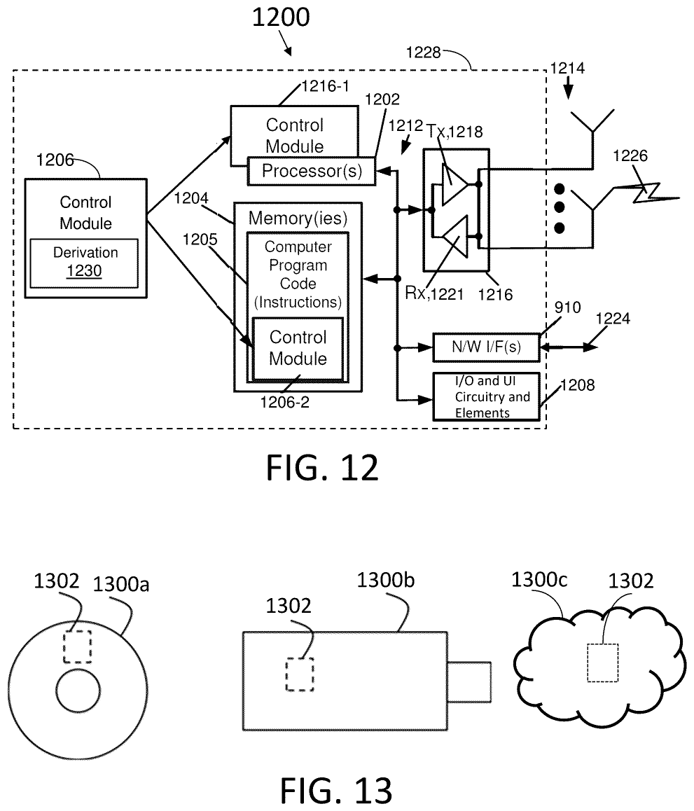

FIG. 12 is an example apparatus 1200, which may be implemented in hardware, configured to implement the examples described herein. The apparatus 1200 comprises one or more processors 1202 (e.g., an FPGA and/or CPU and/or GPU), one or more memories 1204 including computer program code 1205, the computer program code 1205 having instructions to carry out the methods described herein, wherein the one or more memories 1204 and the computer program code 1205 are configured to, with the one or more processors 1202, cause the apparatus 1200 to implement circuitry, a process, component, module, or function (implemented with control module 1206) to implement the examples described herein.

Apparatus 1200 may be a smartphone, personal digital device or assistant, smart television, laptop, pad, tablet, head-mounted display (HMD), or other user device or terminal device. The memory 1204 may be a non-transitory memory, a transitory memory, a volatile memory (e.g. RAM), or a non-volatile memory (e.g., ROM).

Derivation 1230 implements the examples described herein related to derivation of IPM and LFNST modes using content analysis.

The apparatus 1200 includes a display and/or I/O interface 1208, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1200 includes one or more communication e.g. network (N/W) interfaces (I/F(s)) 1210. The communication I/F(s) 1210 may be wired and/or wireless and communicate over the Internet/other network(s) via any communication technique including via one or more links 1224. The communication I/F(s) 1210 may comprise one or more transmitters or one or more receivers.

The transceiver 1216 comprises one or more transmitters 1218 and one or more receivers 1220. The transceiver 1216 and/or communication I/F(s) 1210 may comprise standard well-known components such as an amplifier, filter, frequency-converter, (de)modulator, and encoder/decoder circuitries and one or more antennas, such as antennas 1214 used for communication over wireless link 1226.

The control module 1206 of the apparatus 1200 comprises one of or both parts 1206-1 and/or 1206-2, which may be implemented in a number of ways. The control module 1206 may be implemented in hardware as control module 1206-1, such as being implemented as part of the one or more processors 1202. The control module 1206-1 may be implemented also as an integrated circuit or through other hardware such as a programmable gate array. In another example, the control module 1206 may be implemented as control module 1206-2, which is implemented as computer program code (having corresponding instructions) 1205 and is executed by the one or more processors 1202. For instance, the one or more memories 1204 store instructions that, when executed by the one or more processors 1202, cause the apparatus 1200 to perform one or more of the operations as described herein. Furthermore, the one or more processors 1202, one or more memories 1204, and example algorithms (e.g., as flowcharts and/or signaling diagrams), encoded as instructions, programs, or code, are means for causing performance of the operations described herein.

The apparatus 1200 to implement the functionality of control 1206 may correspond to any of the apparatuses depicted herein. Alternatively, apparatus 1200 and its elements may not correspond to any of the other apparatuses depicted herein, as apparatus 1200 may be part of a self-organizing/optimizing network (SON) node or other node, such as a node in a cloud.

The apparatus 1200 may also be distributed throughout the network including within and between apparatus 1200 and any network element (such as a base station and/or terminal device and/or user equipment).

Interface 1212 enables data communication and signaling between the various items of apparatus 1200, as shown in FIG. 12. For example, the interface 1212 may be one or more buses such as address, data, or control buses, and may include any interconnection mechanism, such as a series of lines on a motherboard or integrated circuit, fiber optics or other optical communication equipment, and the like. Computer program code (e.g. instructions) 1205, including control 1206 may comprise object-oriented software configured to pass data or messages between objects within computer program code 1205. Computer program code (e.g. instructions) 1205, including control 1206 may comprise procedural, functional, or scripting code. The apparatus 1200 need not comprise each of the features mentioned, or may comprise other features as well. The various components of apparatus 1200 may at least partially reside in a common housing 1228, or a subset of the various components of apparatus 1200 may at least partially be located in different housings, which different housings may include the common housing 1228.

FIG. 13 shows a schematic representation of non-volatile memory media 1300a (e.g. computer/compact disc (CD) or digital versatile disc (DVD)) and 1300b (e.g. universal serial bus (USB) memory stick) and 1300c (e.g. cloud storage for downloading instructions and/or parameters 1302 or receiving emailed instructions and/or parameters 1302) storing instructions and/or parameters 1302 which when executed by a processor allows the processor to perform one or more of the operations of the methods described herein. Instructions and/or parameters 1302 may represent or correspond to a non-transitory computer readable medium.

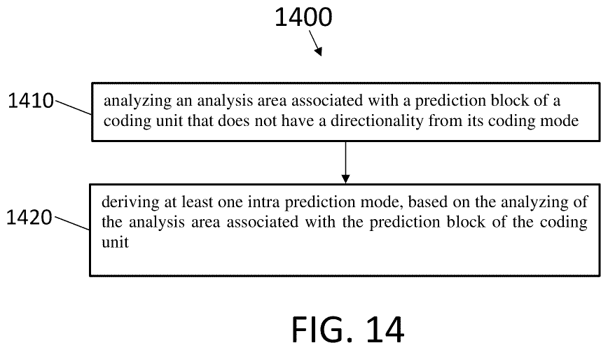

FIG. 14 is an example method 1400, based on the examples described herein. At 1410, the method includes analyzing an analysis area associated with a prediction block of a coding unit that does not have a directionality from its coding mode. In an example embodiment the directionality comprises an obvious directionality. In one or more examples, the obvious directionality may comprise a direction of prediction pattern used to generate the prediction block. At 1420, the method includes deriving at least one intra prediction mode, based on the analyzing of the analysis area associated with the prediction block of the coding unit. Method 1400 may be performed with encoder 900 with derivation 902, decoder 1000 with derivation 1002, transmitting apparatus 1180 with encoding 1190, receiving apparatus 1182 with decoding 1192, or apparatus 1200 with derivation 1230.

The following examples are provided and described herein.
Example 1. An apparatus including: at least one processor; and at least one memory storing instructions that, when executed by the at least one processor, cause the apparatus at least to: analyze an analysis area associated with a prediction block of a coding unit that does not have a directionality from its coding mode; and derive at least one intra prediction mode, based on the analyzing of the analysis area associated with the prediction block of the coding unit. In an embodiment, the directionality comprises an obvious directionality. In one or more examples, the obvious directionality may comprise a direction of prediction pattern used to generate the prediction block.
Example 2. The apparatus of example 1, wherein the analysis area associated with the prediction block comprises samples inside the prediction block.
Example 3. The apparatus of any of examples 1 to 2, wherein the analysis area associated with the prediction block comprises samples in a template outside of the prediction block.
Example 4. The apparatus of any of examples 1 to 3, wherein the apparatus is further caused to: determine at least one dominant direction of the prediction block, based on the analyzing of the analysis area associated with the prediction block; wherein the at least one intra prediction mode is derived based on the at least one dominant direction of the prediction block.
Example 5. The apparatus of any of examples 1 to 4, wherein the coding unit comprises at least one of: an inter coding unit, or an affine coding unit, or an intra block copy coding unit, or a spatial geometric partition mode coding unit, or a geometric partition mode coding unit, an intra template matching coding unit, or a matrix weighted intra prediction coding unit, or a extrapolation filter-based intra prediction unit.
Example 6. The apparatus of any of examples 1 to 5, wherein the analyzing of the analysis area associated with the prediction block comprising applying decoder side intra mode derivation with gradient analysis to the analysis area associated with the prediction block.
Example 7. The apparatus of any of examples 1 to 6, wherein the analyzing of the analysis area associated with the prediction block comprising applying template based intra mode derivation to the analysis area associated with the prediction block.
Example 8. The apparatus of example 7, wherein the template based intro mode derivation is performed with a searching method, wherein the searching method comprises template matching.
Example 9. The apparatus of any of examples 1 to 8, wherein the at least one intra prediction mode is derived from a predetermined table.
Example 10. The apparatus of any of examples 1 to 9, wherein the at least one intra prediction mode is derived from a predetermined function.
Example 11. The apparatus of any of examples 1 to 10, wherein the apparatus is further caused to: generate the prediction block from two partitions in the coding unit, wherein the prediction block is a blended prediction block.
Example 12. The apparatus of example 11, wherein the at least one low frequency non-separable transform mode is derived based on the analyzing of the analysis area associated with the blended prediction block that is generated from the two partitions in the coding unit.
Example 13. The apparatus of any of examples 11 to 12, wherein the coding unit comprises at least one of: a spatial geometric partition mode coding unit, or a geometric partition mode coding unit, or an intra template matching coding unit, or a matrix weighted intra prediction coding unit, or a extrapolation filter-based intra prediction unit.
Example 14. The apparatus of any of examples 1 to 13, wherein the apparatus is further caused to: select a first partition of the coding unit from among two partitions of the coding unit comprising the first partition of the coding unit and a second partition of the coding unit; wherein the analysis area associated with the prediction block used derive the at least one intra prediction mode comprises an area within the first partition of the coding unit.
Example 15. The apparatus of example 14, wherein the first partition of the coding unit used derive the at least one intra prediction mode is larger than and comprises more samples than the second partition of the coding unit that is not used to derive the at least one intra prediction mode.
Example 16. The apparatus of any of examples 14 to 15, wherein the coding unit comprises at least one of: a spatial geometric partition mode coding unit, or a geometric partition mode coding unit an intra template matching coding unit, or a matrix weighted intra prediction coding unit, or a extrapolation filter-based intra prediction unit.
Example 17. The apparatus of any of examples 1 to 16, wherein the at least one intra prediction mode is derived for the prediction block.
Example 18. The apparatus of any of examples 1 to 17, wherein the at least one intra prediction mode is derived for the coding unit.
Example 19. The apparatus of example 18, wherein the at least one intra prediction mode that is derived for the coding unit is used for the prediction block.
Example 20. The apparatus of any of examples 18 to 19, wherein the at least one intra prediction mode that is derived for the coding unit is used for all 4×4 subblocks within the coding unit including the prediction block.
Example 21. The apparatus of any of examples 1 to 20, wherein the apparatus is further caused to: determine whether a 4×4 subblock of the coding unit belongs to a first partition of the coding unit, a second partition of the coding unit, or to both the first partition of the coding unit and the second partition of the coding unit; and determine the at least one intra prediction mode for the 4×4 subblock, based on whether the 4×4 subblock belongs to the first partition of the coding unit, the second partition of the coding unit, or to both the first partition of the coding unit and the second partition of the coding unit.
Example 22. The apparatus of example 21, wherein the apparatus is further caused to: apply decoder side intra mode derivation to the analysis area that is in the first partition of the coding unit to determine an analysis result; and determine the at least one intra prediction mode for the 4×4 subblock based on the analysis result determined based on applying decoder side intra mode derivation to the analysis area that is in the first partition of the coding unit, in response to the 4×4 subblock belonging to the first partition of the coding unit.
Example 23. The apparatus of any of examples 21 to 22, wherein the apparatus is further caused to: apply decoder side intra mode derivation to the analysis area that is in the second partition of the coding unit to determine an analysis result; and determine the at least one intra prediction mode for the 4×4 subblock based on the analysis result determined based on applying decoder side intra mode derivation to the analysis area that is in the second partition of the coding unit, in response to the 4×4 subblock belonging to the second partition of the coding unit.
Example 24. The apparatus of any of examples 21 to 23, wherein the apparatus is further caused to: apply decoder side intra mode derivation to a blended area of the first partition of the coding unit and the second partition of the coding unit to determine an analysis result; and determine the at least one intra prediction mode for the 4×4 subblock based on the analysis result determined based on applying decoder side intra mode derivation to the blended area of the first partition of the coding unit and the second partition of the coding unit, in response to the 4×4 subblock belonging to both the first partition of the coding unit the second partition of the coding unit.
Example 25. The apparatus of any of examples 21 to 24, wherein the prediction block is the 4×4 subblock of the coding unit.
Example 26. The apparatus of any of examples 21 to 25, wherein the at least one intra prediction mode is derived per 4×4 subblock for all 4×4 subblocks of the coding unit, wherein a 4×4 subblock of the 4×4 subblocks is the prediction block.
Example 27. The apparatus of any of examples 1 to 26, wherein the apparatus is further caused to: derive the at least one intra prediction mode for each block within the coding unit, wherein each block is a smaller block within the coding unit that is smaller than the coding unit; analyze, for each of the smaller blocks within the coding unit using a statistical method, a respective analysis area comprising a number of samples associated with a respective smaller block within the coding unit; and determine the at least one intra prediction mode of all 4×4 subblocks within each of the smaller blocks within the coding unit, based on the analyzing of the respective analysis area comprising the number of samples of each of the smaller blocks within the coding unit; wherein the coding unit is an inter coding unit, an affine coding unit, or an intra block copy coding unit.
Example 28. The apparatus of example 27, wherein each smaller block of the smaller blocks comprises dimensions that are 4×4, 4×8, or 8×8.
Example 29. A method including: analyzing an analysis area associated with a prediction block of a coding unit; and deriving at least one intra prediction mode, based on the analyzing of the analysis area associated with the prediction block of the coding unit that does not have a directionality from its coding mode. In an embodiment, the directionality comprises an obvious directionality. In one or more examples, the obvious directionality may comprise a direction of prediction pattern used to generate the prediction block.
Example 30. An apparatus including: means for analyzing an analysis area associated with a prediction block of a coding unit; and means for deriving at least one intra prediction mode, based on the analyzing of the analysis area associated with the prediction block of the coding unit.
Example 31. A computer readable medium including instructions stored thereon for performing at least the following: analyzing an analysis area associated with a prediction block of a coding unit; and deriving at least one intra prediction mode, based on the analyzing of the analysis area associated with the prediction block of the coding unit that does not have a directionality from its coding mode. In an embodiment, the directionality comprises an obvious directionality. In one or more examples, the obvious directionality may comprise a direction of prediction pattern used to generate the prediction block.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
3D three-dimensional
ASIC application specific integrated circuit
CPU central processing unit
CTU coding tree unit
CU coding unit
DIMD decoder side intra mode derivation
ECM enhanced compression model
FPGA field programmable gate array
GPM geometric partition mode
GPU graphics processing unit
HMD head-mounted display
IBC intra block copy
I/F interface
I/O input/output
IPM intra prediction mode
JVET Joint Video Experts Team
LFNST low frequency non-separable transform
MPM most probable mode
N/W network
POC picture order count
RAM random access memory
RFM reference frame memory
ROM read only memory
SBT subblock transform
SGPM spatial geometric partition mode
SON self-organizing/optimizing network
TIMD template based intra mode derivation
UI user interface
USB universal serial bus
VVC versatile video coding

What is claimed is:

1. An apparatus comprising:
at least one processor; and
at least one memory storing instructions that, when executed by the at least one processor, cause the apparatus at least to:
analyze an analysis area associated with a prediction block of a coding unit that does not have a directionality from its coding mode; and
derive at least one intra prediction mode, based on the analyzing of the analysis area associated with the prediction block of the coding unit.

2. The apparatus of claim 1, wherein the analysis area associated with the prediction block comprises samples inside the prediction block.

3. The apparatus of claim 1, wherein the apparatus is further caused to:
determine at least one dominant direction of the prediction block, based on the analyzing of the analysis area associated with the prediction block; and
wherein the at least one intra prediction mode is derived based on the at least one dominant direction of the prediction block.

4. The apparatus of claim 1, wherein the coding unit comprises at least one of:
an inter coding unit, or
an affine coding unit, or
an intra block copy coding unit, or
a spatial geometric partition mode coding unit, or
a geometric partition mode coding unit, or
an intra template matching coding unit, or
a matrix weighted intra prediction coding unit, or
a extrapolation filter-based intra prediction unit.

5. The apparatus of claim 1, wherein the analyzing of the analysis area associated with the prediction block comprising applying decoder side intra mode derivation with gradient analysis to the analysis area associated with the prediction block.

6. The apparatus of claim 1, wherein the at least one intra prediction mode is derived from a predetermined table.

7. The apparatus of claim 1, wherein the at least one intra prediction mode is derived from a predetermined function.

8. The apparatus of claim 1, wherein the coding unit comprises at least one of:
a spatial geometric partition mode coding unit, or
a geometric partition mode coding unit, or
an intra template matching coding unit, or
a matrix weighted intra prediction coding unit, or
a extrapolation filter-based intra prediction unit.

9. The apparatus of claim 1, wherein the at least one intra prediction mode is derived for the prediction block.

10. The apparatus of claim 1, wherein the at least one intra prediction mode is derived for the coding unit.

11. The apparatus of claim 10, wherein the at least one intra prediction mode that is derived for the coding unit is used for the prediction block.

12. The apparatus of claim 10, wherein the at least one intra prediction mode that is derived for the coding unit is used for all 4×4 subblocks within the coding unit including the prediction block.

13. The apparatus of claim 1, wherein the apparatus is further caused to:
determine whether a 4×4 subblock of the coding unit belongs to a first partition of the coding unit, a second partition of the coding unit, or to both the first partition of the coding unit and the second partition of the coding unit; and
determine the at least one intra prediction mode for the 4×4 subblock, based on whether the 4×4 subblock belongs to the first partition of the coding unit, the second partition of the coding unit, or to both the first partition of the coding unit and the second partition of the coding unit.

14. The apparatus of claim 13, wherein the apparatus is further caused to:
apply decoder side intra mode derivation to the analysis area that is in the first partition of the coding unit to determine an analysis result; and
determine the at least one intra prediction mode for the 4×4 subblock based on the analysis result determined based on applying decoder side intra mode derivation to the analysis area that is in the first partition of the coding unit, in response to the 4×4 subblock belonging to the first partition of the coding unit.

15. The apparatus of claim 13, wherein the apparatus is further caused to:
apply decoder side intra mode derivation to the analysis area that is in the second partition of the coding unit to determine an analysis result; and
determine the at least one intra prediction mode for the 4×4 subblock based on the analysis result determined based on applying decoder side intra mode derivation to the analysis area that is in the second partition of the coding unit, in response to the 4×4 subblock belonging to the second partition of the coding unit.

16. The apparatus of claim 13, wherein the apparatus is further caused to:
apply decoder side intra mode derivation to a blended area of the first partition of the coding unit and the second partition of the coding unit to determine an analysis result; and
determine the at least one intra prediction mode for the 4×4 subblock based on the analysis result determined based on applying decoder side intra mode derivation to the blended area of the first partition of the coding unit and the second partition of the coding unit, in response to the 4×4 subblock belonging to both the first partition of the coding unit the second partition of the coding unit.

17. The apparatus of claim 13, wherein the prediction block is the 4×4 subblock of the coding unit.

18. The apparatus of claim 13, wherein the at least one intra prediction mode is derived per 4×4 subblock for all 4×4 subblocks of the coding unit, wherein a 4×4 subblock of the 4×4 subblocks is the prediction block.

19. The apparatus of claim 1, wherein the apparatus is further caused to:
derive the at least one intra prediction mode for each block within the coding unit, wherein the each block is a smaller block within the coding unit that is smaller than the coding unit;
analyze, for each of the smaller blocks within the coding unit using a statistical method, a respective analysis area comprising a number of samples associated with a respective smaller block within the coding unit; and
determine the at least one intra prediction mode of all 4×4 subblocks within each of the smaller blocks within the coding unit, based on the analyzing of the respective analysis area comprising the number of samples of each of the smaller blocks within the coding unit; and
wherein the coding unit is an inter coding unit, an affine coding unit, or an intra block copy coding unit.

20. A method comprising:
analyzing an analysis area associated with a prediction block of a coding unit; and
deriving at least one intra prediction mode, based on the analyzing of the analysis area associated with the prediction block of the coding unit that does not have a directionality from its coding mode.
